(19) United States
(12) Patent Application Publication
(10) Pub. No.: US 2008/0119248 A1
(43) Pub. Date: May 22, 2008

(54) Music control key

(75) Inventors: Lars Nissen, Charlottenlund (DK); Jacob Lykke, Copenhagen (DK); Luke Miles, London (GB)

Correspondence Address: HARRINGTON & SMITH, PC, 4 RESEARCH DRIVE, SHELTON, CT, 06484-6212, US

(73) Assignee: Nokia Corporation

(21) Appl. No.: 11/603,433

(22) Filed: Nov. 21, 2006

(51) Int. Cl. H04M 1/00; G06F 17/00

(52) U.S. Cl. 455/575.4; 455/575.1; 700/94

(57) ABSTRACT

A mobile telephone including a housing; electronic circuitry; and a user interface. The electronic circuitry is located inside the housing and includes a transceiver, a memory and a controller. The electronic circuitry is adapted to play at least one music file stored in the memory. The user interface is located on the housing and coupled to the electronic circuitry. The user interface comprises a music slider key slidably mounted on the housing and adapted to move from a center home position in a first direction and an opposite second direction to at least partially control playing of the at least one music file.

### BACKGROUND OF THE INVENTION

1. Field of the Invention

The invention relates to a music player and, more particularly, to a music player control.

2. Brief Description of Prior Developments

Hand-held portable music players are known in the art, such as an IPOD® music player for example. Mobile telephones are also known to be able to pay music files. Portable telephones having reconfigurable housing members, such as the NOKIA Model 8801 telephone having housing members which slide relative to each other, are also known. On the NOKIA Model 8801 telephone a stationary push-up detail on the housing member which has the display allows a user to manually push up the housing member to expose the keypad.

There is a desire to provide a new type of music function control in a hand-held portable music player.

### SUMMARY OF THE INVENTION

In accordance with one aspect of the invention, a mobile telephone is provided including a housing; electronic circuitry; and a user interface. The electronic circuitry is located inside the housing and includes a transceiver, a memory and a controller. The electronic circuitry is adapted to play at least one music file stored in the memory. The user interface is located on the housing and coupled to the electronic circuitry. The user interface comprises a music slider key slidably mounted on the housing and adapted to move from a center home position in a first direction and an opposite second direction to at least partially control playing of the at least one music file.

In accordance with another aspect of the invention, a portable electronic device is provided comprising a housing, a music control key and a housing movement control system. The housing comprises a first housing member and a second housing member. The second housing member is movably connected to the first housing member. The music control key is connected to the second housing member and is adapted to at least partially control playing of music by the portable electronic device. The housing movement control system can control movement of the second housing member relative to the first housing member from a first position towards a second position. The housing movement control system comprises the music control key.

In accordance with another aspect of the invention, a hand-held portable electronic music player is provided comprising a housing configured to be held in a hand of a user; an electronic display on the housing; and a music control key movably connected to the housing. The music control key is located directly beneath the display generally parallel to a bottom side of the display. The music control key is spring biased in a center home position on the housing and is adapted to be slid on the housing in two opposite lateral directions from the center home position. The music control key is adapted to be moved by a thumb of the user's hand in the two opposite directions while the housing is being held by the user in the user's hand.

In accordance with another aspect of the invention, a method of assembling a portable electronic device is provided comprising connecting a second housing member to a first housing member, wherein the second housing member is movably connected to the first housing member, and wherein the second housing member is adapted to be latched at a closed position relative to the first housing member; and connecting a music control key to the second housing member, wherein the music control key is adapted to control a music player function of the portable electronic device, wherein the music control key is movably mounted to the second housing member. The music control key extends above a major surface of the second housing member and forms a raised user contact surface of a latch release system for moving the second housing member relative to the first housing member from the latched closed position.

### BRIEF DESCRIPTION OF THE DRAWINGS

The foregoing aspects and other features of the invention are explained in the following description, taken in connection with the accompanying drawings, wherein:

FIG. 1 is a front view of a hand-held portable electronic device comprising features of the invention;

FIG. 2 is a perspective view of the device shown in FIG. 1 in an open extended configuration;

FIG. 3 is a perspective view of the device shown in FIG. 2 from an opposite direction;

FIG. 4 is an enlarged partial perspective view of the device shown in FIG. 4;

FIG. 5 is a perspective view of components of the slider key assembly shown in the device of FIG. 4;

FIG. 6 is a cross sectional view of components of the device shown in FIG. 4;

FIG. 7 is a partial cross sectional view of components of the slider key assembly shown in FIG. 5 in a home position;

FIG. 8 is a cross sectional view similar to FIG. 7 when the slider key assembly at a first lateral position;

FIG. 9 is a cross sectional view similar to FIG. 7 when the slider key assembly at a second lateral position;

FIG. 10 is a front view showing connection of the slider key assembly to a printed circuit board and a rear plate;

FIG. 11 is a partial rear view of the components shown in FIG. 10;

FIG. 12 is a slide view of the components shown in FIGS. 10-11;

FIG. 13 is a front view of the device shown in FIG. 1 in a phone mode; and

FIG. 14 is a front view similar to FIG. 13 showing the device in a music mode.

### DETAILED DESCRIPTION OF THE PREFERRED EMBODIMENT

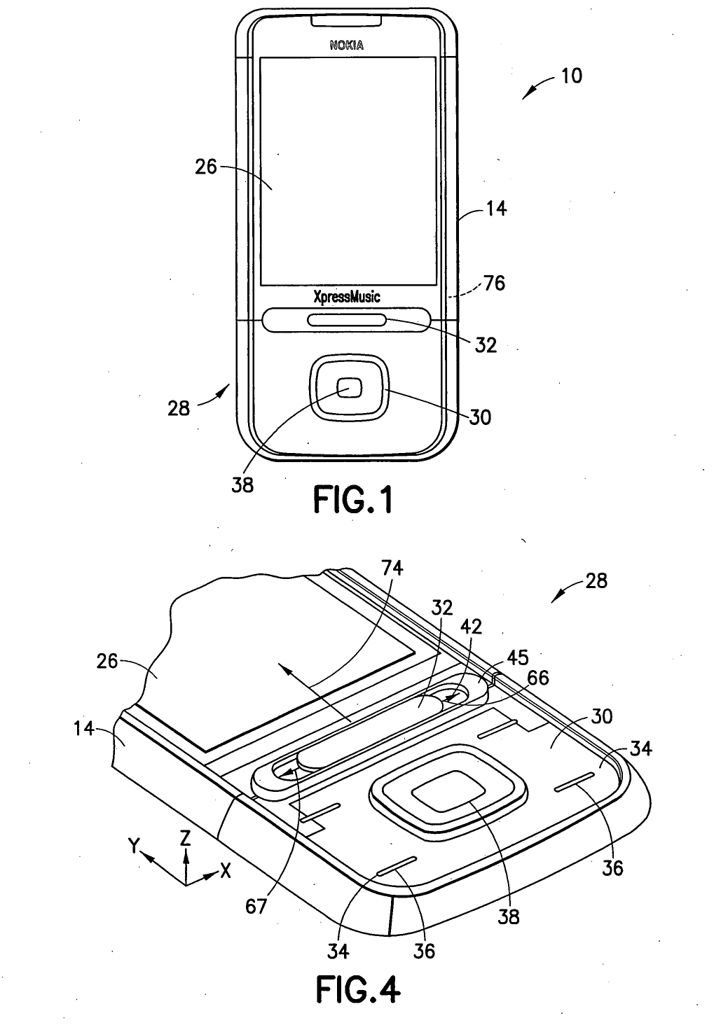

Referring to FIG. 1, there is shown a front view of a portable electronic device 10 incorporating features of the invention. Although the invention will be described with reference to the exemplary embodiment shown in the drawings, it should be understood that the invention can be embodied in many alternate forms of embodiments. In addition, any suitable size, shape or type of elements or materials could be used.

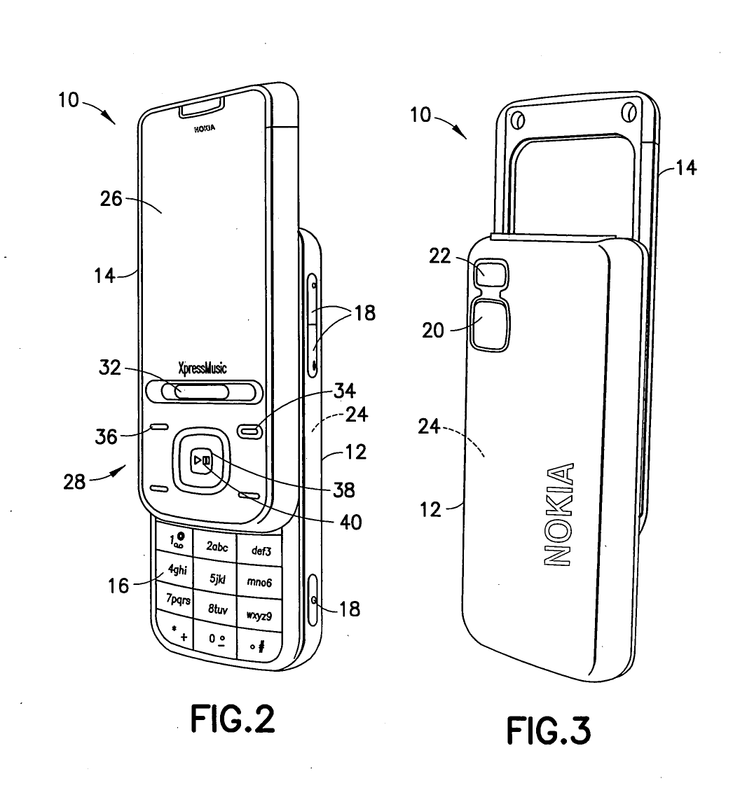

The device 10 in this embodiment is a hand-held, combined mobile telephone and music player. However, features of the invention could be used in any suitable type of portable electronic device, such as only a music player or only a mobile telephone for example. Referring also to FIGS. 2 and 3, the device 10 comprises a first housing member 12 and a second housing member 14. However, in alternate embodiments more or less than two housing members could be provided. The second housing member 14 is movably connected to the first housing member 12. More specifically, the second housing member 14 is slidably mounted to the first housing member 12 between a first closed or collapsed position as shown in FIG. 1, and a second open or extended position as shown in FIGS. 2-3. However, in alternate embodiments any suitable connection of the first and second housing members to each other could be provided.

The first housing member 12 generally comprises a keypad 16, control buttons 18, a camera 20 and a camera flash 22. Electronic circuitry 24 is located in the first housing member 12 which can include for example an antenna, a transceiver, a memory, a controller or processor and other features associated with conventional mobile telephone operation.

Referring also to FIG. 4, the second housing member 14 generally comprises a user interface 28 having an electronic display 26, a five-way navigation key 30 and a control key 32. The navigation key 30 is adapted to be actuated by pressing down at one of its four corners or pressing down at its center to provide five possible selection actuations. In this embodiment, the five-way navigation key 30 has four recessed areas 34 at its four corners with light windows 36. The center 38 of the five-way navigation key 30 also has a recessed area with a light window 40. However, in an alternate embodiment, any suitable type of user input could be used instead of the five-way navigation key 30, such as a joystick, and/or a trackball, and/or multiple separate keys for example.

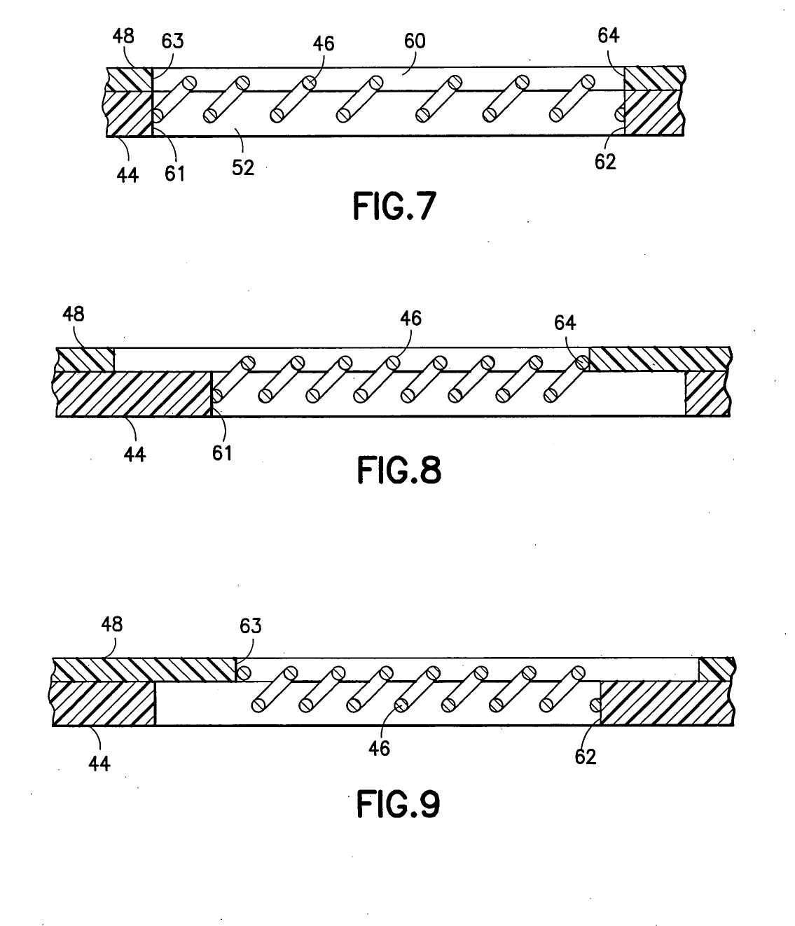

The control key 32 is preferably a dedicated music control key for controlling at least one function of only the music player feature of the device 10. However, in alternate embodiments the control key 32 could also be used for controlling a function of the telephone feature of the device 10. Referring also to FIGS. 5-7, the control key 32 is part of a key module or assembly 42 which includes a frame 44, a spring 46, a support 48 and the key 32. The assembly 42 can also include a key guide 45 at the exterior front of the second housing member 14 for limiting movement of the key 32 in a slot of the guide.

The frame 44 includes a guide slot 50, a spring slot 52 and mounting holes 54. The support 48 has a projection 56 located in the guide slot 50, a projection 58 and a spring slot 60. The key 32 is mounted on the projection 58. The spring 46 is located in the spring slots 52, 60 and contacts ends 62-63 and 64-65 of the slots 52, 60 respectively.

FIGS. 4, 5 and 7 show the assembly 42 when the key 32 is at a center home position. As illustrated by arrows 66 and 67 in FIG. 4, the key 32 is adapted to be moved by a user from the center home position either laterally right or laterally left. Referring also to FIG. 8, when the key 32 is moved to the left, support 48 is moved to the left on the frame 44. This causes the spring 46 to be compressed between ends 61, 64. When the user releases the key 32, the spring 46 biases the support 48 and key 32 back to the center home position. Referring also to FIG. 9, when the key 32 is moved to the right, support 48 is moved to the right on the frame 44. This causes the spring 46 to be compressed between ends 62, 63. When the user releases the key 32, the spring 46 biases the support 48 and key 32 back to the center home position. Thus, the assembly 42 provides a self-centering control key for the device 10.

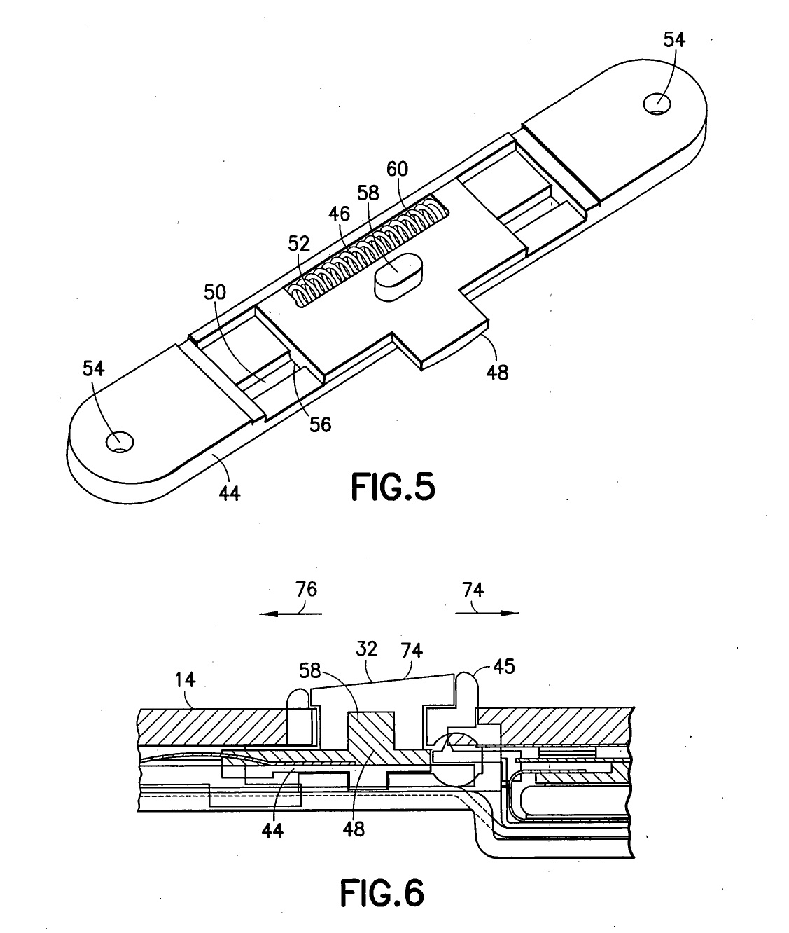

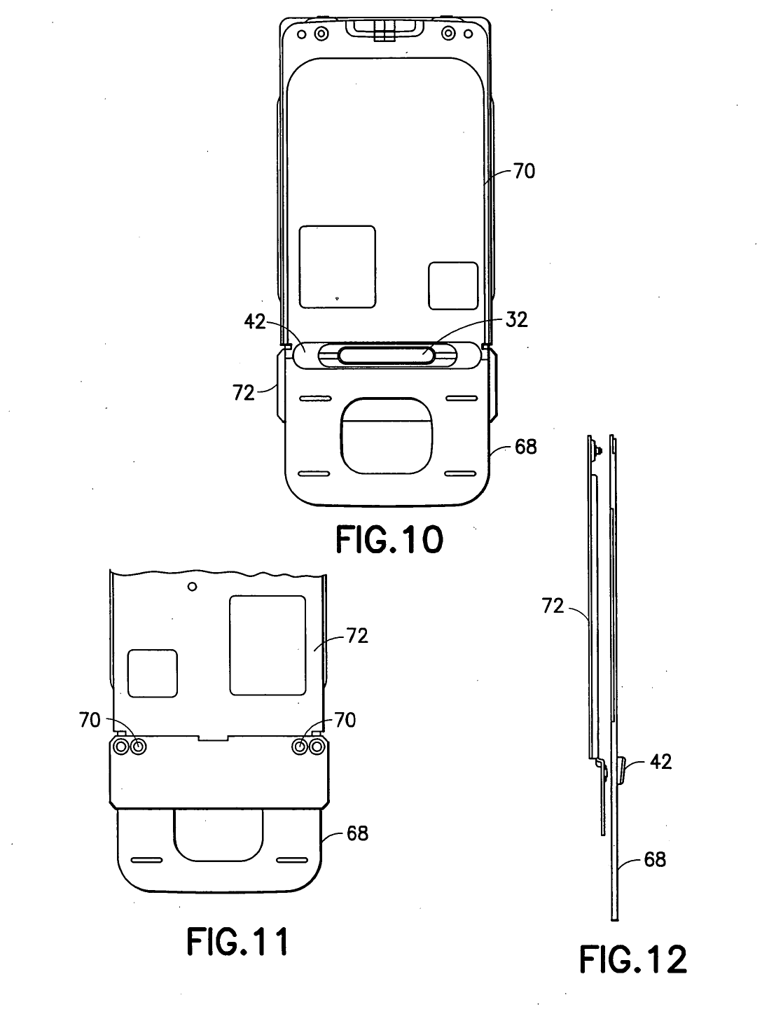

Referring also to FIGS. 10-12, the frame 44 is preferably connected to the front side of a printed circuit board (PCB) 68 by screws 70 screwed in through a plate 72. The support 48 is adapted to provide a switching or signaling contact with the PCB 68 as the support is slid right and left. The music player application in the device 10 is able to use this signaling to perform a music player function, such as Fast-Forward or Reverse for example, and/or moving forward and backward among songs on a playlist, and/or controlling cursor movement on the display. These are only some examples. Any suitable dedicated music player function or other function could be provided. As seen best in FIGS. 4 and 6, the guide 45 prevents movement of the key 32 in y-directions 74 and 76 on the second housing member 14. The key 32 is only moveable in x-directions 66, 67 shown in FIG. 4. Preferably, the top side 74 is inclined as shown in FIG. 6.

As seen in comparing FIG. 1 to FIGS. 2 and 3, for use of some telephone features of the device 10, the second housing member 14 can be slid up relative to the first housing member to an extended position. This can expose the keypad 16. The second housing member 14 is retained at the closed, collapsed position shown in FIG. 1 by a latch system 76. The second housing member 14 could be biased by a spring towards the open, extended position. The latch system can be overcome, and the spring allowed to automatically open the device into its extended position by the user merely initially manually moving the second housing member 14. For this purpose, the control key 32 forms a push-up detail to allow the user to manually push up on the key 32 in direction 74 to overcome the latch system. Pushing up on the key 32 in direction 74 causes the entire second housing member 14 to slide upward on the first housing member 12. Thus, the music slider key 32 also forms part of a housing movement control system for controlling movement of the second housing member relative to the first housing member from a first position towards a second position.

With the invention, a combined telephone and music player can be provided which can stress that it is both a music player and a phone; meaning that the music feature plays a major part of the total device design. To emphasize the music player feature a dedicated key for controlling the music player can be provided. Placement of the key can also emphasize the music player capability of the device. This can be accomplished by a music slider key that can slide to the sides [movement in a ±x-direction] and returns automatically to a center position. The position of the music slider, and the shape of it, makes it natural to implement it also for a push-up detail for the phone slider feature [movement in a ±y-direction].

The function of the music slider is to at least partially activate and control a music player feature in the device, and to be used to slide open housing members of the device for use of the telephone feature. The music key can be both a 2-way self-centering key and a push-up detail for the phone slider. The music slider key can be used to control music player software of the device, as well as forming a push-up detail for the phone slide mechanism. The music slider key can be self-centering. It can slide to the left and to the right.

The music slider key can be provided as part of a music slider module. In one exemplary embodiment the music slider key can move in the x direction about 3-4 mm and returns automatically to the center position. The mechanism can be based on a coil spring centred in the x-direction. The stroke of the music slider can be about 3.5 mm to each side; symmetrically about the centre position.

With the invention, the music control key 32 can be located directly beneath the display 16 generally parallel to a bottom side of the display. The music control key can be spring biased in a center home position on the housing and adapted to be slid on the housing in two opposite lateral directions from the center home position. In the embodiment show, the music control key is adapted to be moved by a thumb of the user's hand in the two opposite directions while the housing is being held by the user in the same hand.

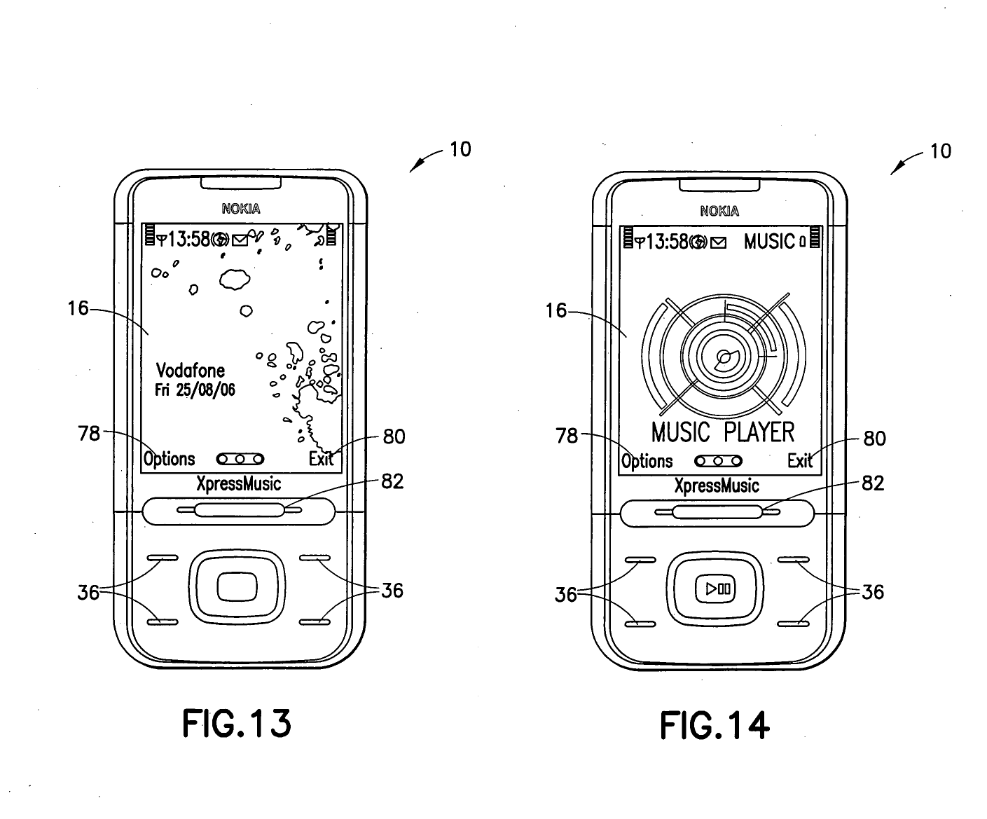

FIG. 1 shows the device 10 with its lights in an OFF mode. Referring also to FIG. 13, the device 10 is shown with in a phone mode, similar to FIGS. 2-3, but in a closed, collapsed position. In this phone mode, the display 16 is illuminated, soft keys 78, 80 light up (such as back printed), the four light windows 36 of the navigation key 30 light up, and the music slider key 32 is lit by a simulated white strip 82. The strip 82 can come from a light behind the guide 45 and pass through a slot or window in the guide 45. Referring also to FIG. 14, the device 10 is shown in a music mode in the closed, collapsed position. In this music mode, the display 16 is illuminated, soft keys 78, 80 light up (such as back printed), the four light windows 40 of the navigation key 30 light up, the music slider key 32 is lit by a simulated white strip 82, and the play/pause key lights 40. A special image is displayed on the display 16. Thus, by looking at the display the user can easily see if the device 10 is in the phone mode or the music mode. If an incoming call is received while in the music mode, the device could be configured to automatically switch to the phone mode, or the user could take appropriate action to switch to the phone mode if desired.

The key 32 is preferably not movable in the Z-direction. However, in an alternate embodiment the latch system 76 might comprise the control key assembly 42. The key 32 could be depressible in the Z-direction to unlatch the latch system 76, and also perhaps act as a push-up detail.

It should be understood that the foregoing description is only illustrative of the invention. Various alternatives and modifications can be devised by those skilled in the art without departing from the invention. Accordingly, the invention is intended to embrace all such alternatives, modifications and variances which fall within the scope of the appended claims.

What is claimed is:

1. A mobile telephone comprising:
a housing;
electronic circuitry located inside the housing, the electronic circuitry including a transceiver, a memory and a controller, wherein the electronic circuitry is adapted to play at least one music file stored in the memory; and
a user interface located on the housing and coupled to the electronic circuitry, wherein the user interface comprises a music slider key slidably mounted on the housing and adapted to move from a center home position in a first direction and an opposite second direction to at least partially control playing of the at least one music file.

2. A mobile telephone as in claim 1 wherein the housing comprises a first housing member and a second housing member, wherein the second housing member is movable mounted to the first housing member, and wherein the first housing member comprises a keypad and the second housing member comprises a display.

3. A mobile telephone as in claim 2 wherein the second housing member is slidably mounted to the first housing member between a first closed position and a second extended position.

4. A mobile telephone as in claim 3 wherein the music slider key is mounted on the second housing member beneath the display, wherein the music slider key is orientated generally parallel to a bottom side of the display, and wherein the first and second directions comprise opposite lateral directions.

5. A mobile telephone as in claim 3 further comprising a latch system for latching the second housing member at the closed position relative to the first housing member, and a latch release system comprising the music slider key.

6. A mobile telephone as in claim 1 wherein the music slider key is biased by a spring at the center home position.

7. A mobile telephone as in claim 1 wherein the housing comprises a first housing member and a second housing member, wherein the second housing member is slidably mounted to the first housing member, wherein the mobile telephone further comprises a latch release system for moving the second housing member from a closed position on the first housing member, and wherein the latch release system comprises the music slider key.

8. A mobile telephone as in claim 1 further comprising a housing movement control system for controlling movement of a second housing member of the housing relative to a first housing member of the housing from a first position towards a second position, wherein the housing movement control system comprises the music slider key.

9. A mobile telephone as in claim 1 wherein the housing is sized and shaped to be held in a hand of a user; wherein the music slider key movably is spring biased in the center home position on the housing, and wherein the music control key is adapted to be moved by a thumb of the user's hand in the first and second directions while the housing is being held by the user in the user's hand.

10. A portable electronic device comprising:
a housing comprising a first housing member and a second housing member, wherein the second housing member is movably connected to the first housing member;
a music control key connected to the second housing member adapted to at least partially control playing of music by the portable electronic device; and
a housing movement control system for controlling movement of the second housing member relative to the first housing member from a first position towards a second position, wherein the housing movement control system comprises the music control key.

11. A portable electronic device as in claim 10 wherein the portable electronic device is a mobile telephone comprising a transceiver.

12. A portable electronic device as in claim 11 wherein the music control key is adapted to control a mobile telephone function.

13. A portable electronic device as in claim 10 wherein the second housing member is slidably connected to the first housing member.

14. A portable electronic device as in claim 10 wherein the music control key is slidably connected to the second housing member.

15. A portable electronic device as in claim 14 wherein the portable electronic device comprises a display on the second housing member, and wherein the music control key has a general elongate shape and is located below the display and orientated generally parallel to the bottom side of the display.

16. A portable electronic device as in claim 14 wherein the music control key is biased by a spring at a center home position, and is adapted to be slid on the second housing member from the center home position in a first lateral direction and a second opposite lateral direction.

17. A hand-held portable electronic music player comprising:
a housing configured to be held in a hand of a user;
an electronic display on the housing; and
a music control key movably connected to the housing, wherein the music control key is located directly beneath the display generally parallel to a bottom side of the display, wherein the music control key is spring biased in a center home position on the housing and is adapted to be slid on the housing in two opposite lateral directions from the center home position, wherein the music control key is adapted to be moved by a thumb of the user's hand in the two opposite directions while the housing is being held by the user in the user's hand.

18. A hand-held portable electronic music player as in claim 17 wherein the housing comprises a first housing member and a second housing member, wherein the second housing member is slidably mounted to the first housing member.

19. A hand-held portable electronic music player as in claim 18 wherein the second housing member is slidably mounted to the first housing member between a first collapsed position and a second extended position.

20. A hand-held portable electronic music player as in claim 19 further comprising a latch system for latching the second housing member at the collapsed position relative to the first housing member, and a latch release system comprising the music control key.

21. A hand-held portable electronic music player as in claim 17 further comprising a housing movement control system for controlling movement of a second housing member of the housing relative to a first housing member of the housing from a first position towards a second position, wherein the housing movement control system comprises the music control key.

22. A method of assembling a portable electronic device comprising:
connecting a second housing member to a first housing member, wherein the second housing member is movably connected to the first housing member, and wherein the second housing member is adapted to be latched at a closed position relative to the first housing member; and
connecting a music control key to the second housing member, wherein the music control key is adapted to control a music player function of the portable electronic device, wherein the music control key is movably mounted to the second housing member,
wherein the music control key extends above a major surface of the second housing member and forms a raised user contact surface of a latch release system for moving the second housing member relative to the first housing member from the latched closed position.
